(19) United States
(12) Patent Application Publication
(10) Pub. No.: US 2026/0167841 A1
(43) Pub. Date: Jun. 18, 2026

(54) BIO COATING COMPOSITION COMPRISING RECYCLED PIGMENTS AND METHOD FOR MANUFACTURING THE SAME

(71) Applicants: Hyundai Motor Company, Seoul (KR); Kia Corporation, Seoul (KR); Noroo Automotive Coatings Co., Ltd., Hwaseong (KR); Hyundai Mobis Co., Ltd., Seoul (KR)

(72) Inventors: Chanul Jeong, Hwaseong (KR); Jaejin Lee, Hwaseong (KR); Sung Kyu Lee, Hwaseong (KR); Hoon Kwan Joo, Cheonan (KR); Sang Pil Park, Seoul (KR); Ju Hyuk Park, Cheonan (KR); Young Chan Cho, Yongin (KR); Jae Beom Ahn, Anyang (KR)

(21) Appl. No.: 19/221,243

(22) Filed: May 28, 2025

(30) Foreign Application Priority Data
Dec. 16, 2024 (KR) 10-2024-0186731

(51) Int. Cl. C09D 133/02

(52) U.S. Cl. CPC C09D 133/02

(57) ABSTRACT

Provided are a bio coating composition comprising recycled pigments and a method for manufacturing the same. The bio coating composition of the present disclosure is an eco-friendly composition with a high bio content and reduced carbon emissions, and can satisfy properties required for automotive interior materials, such as chemical resistance, heat resistance, and hydrolysis resistance, comprising sunscreen resistance.

### CROSS-REFERENCE TO RELATED APPLICATION

This present application claims under 35 U.S.C. 119 (a) the benefit of Korean Patent Application No. 10-2024-0186731, entitled “BIO COATING COMPOSITION COMPRISING RECYCLED PIGMENTS AND METHOD OF MANUFACTURING THE SAME,” filed on Dec. 16, 2024, in the Korean Intellectual Property Office, the entire disclosure of which is incorporated herein by reference.

### BACKGROUND

### Technical Field

The present disclosure relates to a bio coating composition comprising recycled pigments and a method for manufacturing the same.

### Background

Recently, as interest in the environment has increased, many efforts are being made in various fields to reduce carbon dioxide, which is identified as a major contributor of global warming.

Accordingly, biomass raw materials instead of conventional oil and coal resources are in the spotlight. Since the sum of carbon dioxide emissions and absorption in the life cycle on Earth is zero, the biomass raw materials do not increase the amount of carbon dioxide in the atmosphere. In addition, the biomass raw materials may be an essential choice not only for environmental issues but also the replacement of petroleum resources that are being depleted.

In addition, a large amount of organic polymer waste such as waste tires and waste plastics is generated in Korea and abroad. In particular, about 1.5 billion waste tires are generated worldwide every year, weighing about 15 million tons. In Korea, about 380,000 tons of waste tires were generated in 2021. The treatment of these wastes is divided into landfill, incineration, and recycling. The landfill has a problem of continuously developing suitable landfill sites because waste tires and waste plastics do not decompose easily, and is decreasing in the proportion among waste treatment methods as soil contamination issues become more important. Meanwhile, the incineration has an advantage of minimizing the volume in a short period of time and utilizing the heat generated during incineration. However, the emission of air pollutants, such as dioxins generated during incineration, remains a concern.

As the development of eco-friendly automobiles becomes more active, coating compositions with the high bio content are required for application to automobile interior plastic parts. However, as the content of bio resins increases, the properties such as sunscreen resistance, chemical resistance, heat resistance, and hydrolysis resistance decrease due to the characteristics compared to petroleum-derived resins, making it difficult to satisfy the properties required for automobile interior materials. In addition, recycled pigments obtained by pyrolyzing waste tires have a high carbon reduction effect compared to petroleum-derived pigments, but due to inherent characteristics such as pigment size and the like, the recycled pigments have poor dispersibility and coloring compared to conventional pigments to have disadvantages of poor workability and appearance.

Therefore, research and development on eco-friendly bio coating compositions that satisfy the properties, and the like required for automobile interior materials are required.

### SUMMARY

In order to solve the problems, in some embodiments, the present disclosure provides an eco-friendly bio coating composition having excellent properties and a method for manufacturing the same.

In some embodiments, the present disclosure provides a bio coating composition applicable to green technology fields such as interior materials for electric vehicles and the like, and a method for manufacturing the same.

In one aspect, a coating composition is provided suitably comprising: a) a polyurethane resin; and b) an acrylic resin component wherein the biomass acrylic resin comprises a first acrylic resin having an acid value of about 3.5 mgKOH/g or less and a glass transition temperature of about 75 to 80° C.; and a second acrylic resin having an acid value of about 3.0 mgKOH/g or less and a glass transition temperature of about 80 to 90° C. In certain embodiments, the composition suitably further comprises c) an additive component that is distinct from the a) polyurethane resin and b) the acrylic resin component.

Preferably, the a) polyurethane resin and/or b) the acrylic resin component (which includes the first acrylic component and the second acrylic resin) are substantially biomass-resource-derived, i.e. the materials are derived from biomass resources rather than dreived from petroleum-based sources. For example, in aspects, preferably at least 10, 20, 30, 40, 50, 60, 70, 80, 90, 95 or 100 weight percent of the a) polyurethane resin and/or) the acrylic resin component (which includes the first acrylic component and the second acrylic resin) are derived from biomass-related materials rather than petroleum-based materials.

In aspects, preferably at least 50, 60, 70, 80, 90, 95, 98 or 100 weight percnt of the polyurethane resin and acrylic resin component are are derived from biomass-related materials. In aspects, preferably at least 70, 80, 90, 95, 98 or 100 weight percnt of the polyurethane resin and acrylic resin component are are derived from biomass-related materials.

In further aspects, an embodiment of the present disclosure provides a bio coating composition, comprising a) a biomass polyurethane resin; b) a biomass acrylic resin component; in which the biomass acrylic resin comprises a first biomass acrylic resin having an acid value of 3.5 mgKOH/g or less and a glass transition temperature of 75 to 80° C.; and a second biomass acrylic resin having an acid value of 3.0 mgKOH/g or less and a glass transition temperature of 80 to 90° C. In certain embodiments, the composition suitably further comprises c) an additive component that is distinct from the a) polyurethane resin and b) the acrylic resin component.

In one example of the present disclosure, the biomass acrylic resin may comprise at least one monomer from an aliphatic group-containing methacrylic monomer, an aliphatic group-containing acrylic monomer, an alicyclic group-containing methacrylic monomer, an alicyclic group-containing acrylic monomer, a hydroxyl group-containing methacrylic monomer, and a hydroxyl group-containing acrylic monomer.

In one example of the present disclosure, the aliphatic group-containing methacrylic monomer may comprise one selected from the group consisting of butyl methacrylate, methyl methacrylate, ethyl methacrylate, 2-ethylhexyl methacrylate, lauryl methacrylate, hydroxyethyl methacrylate, and combinations thereof, the aliphatic group-containing acrylic monomer may comprise one selected from the group consisting of butylacrylate, ethyl acrylate, and combinations thereof, the alicyclic group-containing methacrylic monomer may comprise one selected from the group consisting of isobornyl methacrylate, cyclohexyl methacrylate, and combinations thereof, the alicyclic group-containing acrylic monomer may comprise one selected from the group consisting of 2-ethylhexylacrylate, isobornyl acrylate, trimethylcyclohexylacrylate, and combinations thereof, and the hydroxyl group-containing methacrylic monomer may comprise one selected from the group consisting of methacrylic acid, acrylic acid, 2-hydroxyethyl methacrylate and combinations thereof.

In one example of the present disclosure, the biomass acrylic resin may have a hydroxyl value of 50 to 100 mgKOH/g.

In one example of the present disclosure, the additive may comprise one selected from the group consisting of pigments, wetting and dispersing agents, reaction catalysts, matting agents, anti-settling agents, surface additives, solvents, and combinations thereof.

In one example of the present disclosure, the pigment may be recycled pigments.

In one example of the present disclosure, the biomass polyurethane resin may have a weight average molecular weight of 40,000 to 43,000 g/mol, a hydroxyl value of 200 to 300 mgKOH/g, and a glass transition temperature (Tg) of 30 to 32° C.

In one example of the present disclosure, the bio coating composition may comprise 15 to 25 wt % of a biomass polyurethane resin; 25 to 30 wt % of a first biomass acrylic resin; 10 to 20 wt % of a second biomass acrylic resin; and 19 to 47 wt % of an additive.

In one example of the present disclosure, the bio coating composition may comprise 15 to 25 wt % of a biomass polyurethane resin; 25 to 30 wt % of a first biomass acrylic resin; 10 to 20 wt % of a second biomass acrylic resin; 1.0 to 3.5 wt % of a recycled pigment; 0.1 to 1.5 wt % of a reaction catalyst; 1.5 to 3.5 wt % of a matting agent; 3.0 to 7.0 wt % of an anti-settling agent; 0.1 to 1.0 wt % of a surface additive; 1 to 10 wt % of a wetting and dispersing agent; and 10 to 25 wt % of a solvent.

Another embodiment of the present disclosure provides a method for manufacturing a bio coating composition comprising: preparing a biomass acrylic resin; preparing a biomass polyurethane resin; and preparing a coating composition by mixing the biomass acrylic resin, the biomass polyurethane resin, and an additive, in which the biomass acrylic resin comprises a first biomass acrylic resin having an acid value of 3.5 mgKOH/g or less and a glass transition temperature of 75 to 80° C.; and a second biomass acrylic resin having an acid value of 3.0 mgKOH/g or less and a glass transition temperature of 80 to 90° C.

In some embodiments, a method for manufacturing a bio coating composition involves preparing a biomass acrylic resin, a biomass polyurethane resin, and a coating composition by mixing these resins. The biomass acrylic resin includes a first biomass acrylic resin with an acid value of about 3.5 mgKOH/g or less and a glass transition temperature of about 75 to 80° C., and a second biomass acrylic resin with an acid value of about 3.0 mgKOH/g or less and a glass transition temperature of about 80 to 90° C.

In this method, the biomass acrylic resin is prepared by radical-polymerizing about 98 to 99.9 wt % of the monomer and about 0.1 to 2 wt % of the radical initiator.

The biomass acrylic resin comprises at least one monomer selected from a group consisting of a biomass-based aliphatic group-containing methacrylic monomer, an aliphatic group-containing acrylic monomer, an alicyclic group-containing methacrylic monomer, an alicyclic group-containing acrylic monomer, an aromatic group-containing methacrylic monomer, an aromatic group-containing acrylic monomer, a hydroxyl group-containing acrylic monomer, and a radical initiator.

The biomass acrylic resin may have a hydroxyl value of about 50 to 100 mgKOH/g.

The biomass polyurethane resin may have a weight average molecular weight of about 40,000 to 43,000 g/mol, a hydroxyl value of about 200 to 300 mgKOH/g, and a glass transition temperature (Tg) of about 30 to 32° C.

The solvent used in preparing the biomass acrylic resin may be an ester or a ketone.

The method may further include adding a curing agent in an amount of about 5 to 30 parts by weight based on 100 parts by weight of the coating composition.

The coating composition may be prepared by mixing the biomass acrylic resin, the biomass polyurethane resin, and an additive, where the additive comprises about 1.0 to 3.5 wt % of a recycled pigment.

The bio coating composition may be formed by mixing about 15 to 25 wt % of the biomass polyurethane resin, about 25 to 30 wt % of the first biomass acrylic resin, about 10 to 20 wt % of the second biomass acrylic resin, and about 19 to 47 wt % of an additive.

Preparing the biomass polyurethane resin may involve reacting a polyol, a chain extender, and an isocyanate in an organic solvent to obtain a biomass polyurethane resin containing hydroxyl groups.

In some embodiments, a bio coating composition comprises about 15 to 25 wt % of a biomass polyurethane resin, about 25 to 30 wt % of the first biomass acrylic resin, and about 10 to 20 wt % of the second biomass acrylic resin, where the first biomass acrylic resin has an acid value of about 3.5 mgKOH/g or less and a glass transition temperature of about 75 to 80° C., and the second biomass acrylic resin has an acid value of about 3.0 mgKOH/g or less and a glass transition temperature of about 80 to 90° C.

According to an embodiment of the present disclosure, it is possible to provide an eco-friendly bio coating composition having a high bio content and reduced carbon emissions.

According to another embodiment of the present disclosure, it is possible to provide a bio coating composition capable of satisfying properties required by automobile interior materials, such as chemical resistance, heat resistance, and hydrolysis resistance, comprising sunscreen resistance.

According to yet another embodiment of the present disclosure, it is possible to provide a bio coating composition having excellent workability and aesthetics.

As discussed, the method and system suitably include use of a controller or processer.

In another embodiment, vehicles are provided that comprise an apparatus as disclosed herein.

### DETAILED DESCRIPTION

Hereinafter, the present disclosure will be described in more detail. However, the following embodiments or examples are only a reference for explaining the present disclosure in detail, and the present disclosure is not limited thereto, and may be implemented in various forms.

Further, unless otherwise defined, all technical and scientific terms have the same meaning as commonly understood by those skilled in the art to which the present disclosure pertains.

The terminology used in the description herein is merely to effectively describe specific embodiments and is not intended to limit the present disclosure.

In addition, as used in the specification and the appended claims, the singular forms may be intended to comprise plural forms, unless clearly dictated in the contexts otherwise.

In addition, units used in this specification without special mention are based on weight, and for example, units of % or ratio mean wt % or weight ratio, and wt % means wt % of any one component in the entire composition, unless otherwise defined.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

In addition, the numerical ranges used herein may comprise lower and upper limits and all values within that range, increments logically derived from the shape and width of the defined range, all doubly defined values, and all possible combinations of upper and lower limits of numerical ranges defined in different shapes. Unless otherwise specifically defined in the specification of the present disclosure, values out of the numerical range that may arise due to experimental error or rounding of values are also comprised in the defined numerical range.

The term “biomass acrylic resin” used herein refers to an acrylic polymer resin in which at least a portion of the monomer units is derived from renewable, plant-based, or otherwise bio-sourced materials (e.g., corn, soy, cellulose, or other feedstocks).

The term “biomass polyurethane resin” used herein refers to a polyurethane polymer resin that includes renewable or bio-sourced components (e.g., polyols derived fromvegetable oils, cellulose, or other plant materials) in its backbone or side chains, thereby reducing the petrochemical content compared to conventional polyurethane resins.

The term “bio coating composition” used herein refers to a coating formulation in which one or more components (e.g., binder resins, additives) are derived partially or wholly from biomass sources.

The term “biomass resources” as used herein incudes materials in which the energy of sunlight has been stored by photosynthesis i.e. plant materials; animal bodies which have grown by eating plant bodies; and products available by processing the plant bodies or animal bodies. Plant materials are typical biomass materials. Examples include wood, rice materials, corn, sugarcanes, plant oil wastes, potatoes, soybeans, used paper and materials after paper manufacture, residues of marine products, livestock excrement, sewage sludge.

The term “radical initiator” used herein refers to a compound that, upon decomposition or activation, generates free radicals.

The term “chain extender” used herein refers to a reactant containing at least to functional groups used in polyurethane synthesis to lengthen polymer chains.

The term “hydroxyl value” used herein refers to the number of milligrams of potassium hydroxide (mgKOH) reuqired to neturalize the fully acetylated derivative prepared from one gram of sample.

The term “acid value” used herein refers to the amount of free acid groups present in a sample, expressed as the milligrams of potassium hydroxide (mgKOH) needed to neutralize the acids in one gram of the sample.

In addition, the term “biomass-based” used herein means derived from various biological resources such as plants, microorganisms, animals, and wastes, rather than from petrochemicals.

Hereinafter, the present disclosure will be described in more detail.

The present disclosure relates to a bio coating composition and a method for manufacturing the same, which comprises a biomass polyurethane resin; a biomass acrylic resin; and an additive, in which the biomass acrylic resin comprises a first biomass acrylic resin having an acid value of 3.5 mgKOH/g or less and a glass transition temperature of 75 to 80° C.; and a second biomass acrylic resin having an acid value of 3.0 mgKOH/g or less and a glass transition temperature of 80 to 90° C. The bio coating composition may secure excellent coating film properties while implementing a high bio content by comprising various types of biomass resins. As such, the bio coating composition of the present disclosure may be used as an eco-friendly coating suitable for interior materials of automobiles comprising electric vehicles by organically combining the components of the biomass resin and the additive.

The present disclosure provides a bio coating composition, which comprises a biomass polyurethane resin; a biomass acrylic resin; and an additive, in which the biomass acrylic resin comprises a first biomass acrylic resin having an acid value of 3.5 mgKOH/g or less and a glass transition temperature of 75 to 80° C.; and a second biomass acrylic resin having an acid value of 3.0 mgKOH/g or less and a glass transition temperature of 80 to 90° C.

The biomass polyurethane resin and the biomass acrylic resin of the present disclosure are used as main resins that determine the bio content of the coating composition.

In one example of the present disclosure, the biomass polyurethane resin may have a weight average molecular weight of 40,000 to 43,000 g/mol, and a glass transition temperature (Tg) of 30 to 32° C. In one example of the present disclosure, the biomass polyurethane resin may have a hydroxyl value of 200 to 300 mgKOH/g, specifically 220 to 250 mgKOH/g.

In one example of the present disclosure, the bio coating composition may comprise 15 to 31 wt %, 15 to 25 wt %, specifically 17 to 23 wt % of the biomass polyurethane resin. If the biomass polyurethane resin is less than 15 wt %, the requirements of the bio coating may not be satisfied, and if the biomass polyurethane resin exceeds 25 wt %, the hardness of the coating film may be lowered, the surface may become sticky, and scratch resistance and acetone resistance may be deteriorated.

In one example of the present disclosure, the biomass acrylic resin may comprise at least one monomer from biomass-based aliphatic group-containing methacrylic monomer, aliphatic group-containing acrylic monomer, aromatic group-containing acrylic monomer, alicyclic group-containing methacrylic monomer, alicyclic group-containing acrylic monomer, hydroxyl group-containing acrylic monomer, and hydroxyl group-containing methacrylic monomer.

In one example of the present disclosure, the aliphatic group-containing methacrylic monomer may comprise one selected from the group consisting of butyl methacrylate, methyl methacrylate, ethyl methacrylate, 2-ethylhexyl methacrylate, lauryl methacrylate, hydroxyethyl methacrylate, and combinations thereof.

In one example of the present disclosure, the aliphatic group-containing acrylic monomer may comprise one selected from the group consisting of butyl acrylate, ethyl acrylate, and combinations thereof.

In one example of the present disclosure, the alicyclic group-containing acrylic monomer may comprise one selected from the group consisting of 2-ethylhexylacrylate, isobornyl acrylate, trimethylcyclohexylacrylate, and combinations thereof.

In one example of the present disclosure, the alicyclic group-containing methacrylic monomer may comprise one selected from the group consisting of isobornyl methacrylate, cyclohexyl methacrylate, and combinations thereof.

In one example of the present disclosure, the aromatic group-containing acrylic monomer may comprise a styrene monomer.

In one example of the present disclosure, the hydroxyl group-containing methacrylic monomer may comprise one selected from the group consisting of methacrylic acid, acrylic acid, and combinations thereof.

The biomass acrylic resin of the present disclosure may comprise a first biomass acrylic resin and a second biomass acrylic resin.

In one example of the present disclosure, the first biomass acrylic resin may have an upper limit of the acid value of 3.5 mgKOH/g or less, 3.0 mgKOH/g or less, 2.5 mgKOH/g or less, or 2.0 mgKOH/g or less, and a lower limit of more than 0.05 mgKOH/g, more than 0.10 mgKOH/g, more than 0.20 mgKOH/g, or more than 0.50 mgKOH/g. In one example of the present disclosure, the first biomass acrylic resin may have the hydroxyl value of 26 to 50 mgKOH/g, specifically, 30 to 35 mgKOH/g, the glass transition temperature of 75 to 80° C., and the weight average molecular weight of 35,000 to 40,000 g/mol.

In one example of the present disclosure, the second biomass acrylic resin may have an upper limit of the acid value of 3.0 mgKOH/g or less, 2.5 mgKOH/g or less, 2.0 mgKOH/g or less, or 1.5 mgKOH/g or less, and a lower limit of more than 0.05 mgKOH/g, more than 0.10 mgKOH/g, more than 0.20 mgKOH/g, or more than 0.50 mgKOH/g. In one example of the present disclosure, the second biomass acrylic resin may have the hydroxyl value of 10 to 25 mgKOH/g, specifically, 20 to 25 mgKOH/g, the glass transition temperature of 80 to 90° C., and the weight average molecular weight of 20,000 to 30,000 g/mol.

In one example of the present disclosure, the bio coating composition may comprise 25 to 30 wt % of the first biomass acrylic resin and 10 to 20 wt % of the second biomass acrylic resin. At this time, if the first biomass acrylic resin is less than 25 wt %, chemical resistance and adhesion performance after a reliability test may deteriorate, and if the first biomass acrylic resin exceeds 45 wt %, the coating appearance quality may deteriorate, and if the second biomass acrylic resin is less than 10 wt %, chemical resistance may deteriorate and the coating film may partially expand, and if the second biomass acrylic resin exceeds 15 wt %, the coating appearance quality may deteriorate.

The bio coating composition of the present disclosure may further comprise an additive to change the properties of the coating or impart characteristics.

In one example of the present disclosure, the additive may further comprise any one selected from the group consisting of a pigment, a wetting and dispersing agent, a reaction catalyst, a matting agent, an anti-settling agent, a surface additive, an ultraviolet absorber, a solvent, and a combination thereof, and specifically may comprise a pigment, a wetting and dispersing agent, a reaction catalyst, a matting agent, an anti-settling agent, a surface additive, an ultraviolet absorber, and a solvent.

In one example of the present disclosure, the pigment may be recycled pigments.

In one example of the present disclosure, the additive may comprise the recycled pigment and the wetting and dispersing agent in a weight ratio of 1:1 to 1:5, specifically 1:1.5 to 1:3, and more specifically 1:1.8 to 1:2.2. When the weight ratio is satisfied, the coating composition has excellent compatibility, thermal stability, and blackness.

In one example of the present disclosure, the bio coating composition may comprise 19 to 47 wt % of an additive. More specifically, the bio coating composition may comprise 1.0 to 3.5 wt % of the recycled pigment; 0.1 to 1.5 wt % of the reaction catalyst; 1.5 to 3.5 wt % of the matting agent; 3.0 to 7.0 wt % of the anti-settling agent; 0.1 to 1.0 wt % of the surface additive; 1 to 10 wt % of the wetting and dispersing agent; and 10 to 25 wt % of the solvent.

Further, the present disclosure provides a method for manufacturing a bio coating composition, comprising preparing a biomass acrylic resin; preparing a biomass polyurethane resin; and preparing a coating composition by mixing the biomass acrylic resin, the biomass polyurethane resin, and an additive.

In the description of the method for manufacturing the bio coating composition, the content of the bio coating composition will be omitted as described above.

The preparing of the biomass acrylic resin of the present disclosure is a step of preparing a biomass acrylic resin by radically polymerizing at least one monomer from biomass-based aliphatic group-containing methacrylic monomer, aliphatic group-containing acrylic monomer, aromatic group-containing acrylic monomer, alicyclic group-containing methacrylic monomer, alicyclic group-containing acrylic monomer, hydroxyl group-containing acrylic monomer, and hydroxyl group-containing methacrylic monomer and a radical initiator in a solvent.

In one example of the present disclosure, the biomass acrylic resin may be prepared by radically polymerizing 98 to 99.9 wt % of the monomer and 0.1 to 2 wt % of the radical initiator, but is not limited thereto.

The biomass acrylic resin of the present disclosure may comprise a first acrylic resin and a second acrylic resin. Specifically, the biomass acrylic resin may comprise a first biomass acrylic resin having an acid value of 3.5 mgKOH/g or less and a glass transition temperature of 75 to 80° C.; and a second biomass acrylic resin having an acid value of 3.0 mgKOH/g or less and a glass transition temperature of 80 to 90° C.

In one example of the present disclosure, the radical initiator used in the synthesis of the first biomass acrylic resin and the second biomass acrylic resin may comprise at least one organic peroxide selected from benzoyl peroxide, tert-butylperoxybenzoate, tert-butylperoxy-2-ethylhexanoate, tert-aminoethylperoxy-2-ethylhexanoate, and the like.

In one example of the present disclosure, the solvent used in the synthesis of the first biomass acrylic resin and the second biomass acrylic resin may be any one of esters such as n-butyl acetate and ethylene glycol ethyl ether acetate, and ketones such as methyl isobutyl ketone and methyl normal amyl ketone.

The preparing of the biomass polyurethane resin of the present disclosure may comprise preparing a mixed solution by adding an acrylic resin and isocyanate to an organic solvent; and synthesizing the biomass polyurethane resin by adding biopolyol to the mixed solution. Specifically, the preparing of the biomass polyurethane resin is a step of preparing a mixed solution by reacting an acrylic resin containing a hydroxyl group and isocyanate, and then preparing the biomass polyurethane resin by adding plant-derived biopolyol to the mixed solution.

In one example of the present disclosure, the biomass polyurethane resin may be synthesized by adding 30 to 60 parts by weight of isocyanate based on 100 parts by weight of the acrylic resin to prepare a mixed solution, and adding 100 to 150 parts by weight of biopolyol based on 100 parts by weight of the mixed solution.

In one example of the present disclosure, the isocyanate comprises one selected from the group consisting of hexamethylene isophorone diisocyanate, dicyclohexylmethane diisocyanate, and combinations thereof.

In one example of the present disclosure, the biopolyol may be synthesized from plant and animal oils derived from biomass resources without containing hydroxyl groups. The synthetic method comprises a method of introducing a hydroxyl group into a carbon double bond of an unsaturated fatty acid chain of plant and animal oil through epoxidation and ring opening reactions, a hydroformylation synthesis method of introducing a hydroxyl group through a hydrogenation reaction after hydroformylation of a carbon double bond like epoxidation, a synthesis method through ozonolysis of introducing a hydroxyl group through hydrogenation after cleaving a carbon double bond using ozone (O₃), and the like.

In one example of the present disclosure, the biopolyol may have a weight average molecular weight of 500 to 10,000 g/mol, and 1,000 to 5,000 g/mol. When the range is satisfied, it is advantageous in terms of chemical resistance and productivity of the coating composition.

In one example of the present disclosure, the number of functional groups of the hydroxyl groups of the biopolyol may be 2 to 8.

In one example of the present disclosure, the organic solvent may be selected from esters such as n-butyl acetate and ethylene glycol ethyl ether acetate, and ketones such as methyl isobutyl ketone, and methyl normal amyl ketone.

Next, the method comprises preparing a coating composition by mixing the biomass acrylic resin, the biomass polyurethane resin, and an additive.

In one example of the present disclosure, the coating composition may further comprise a curing agent for curing, and at this time, the curing agent may be comprised in an amount of 10 to 50 parts by weight, specifically 15 to 30 parts by weight, based on 100 parts by weight of the coating composition.

In one example of the present disclosure, the curing agent may be hexamethylene diisocyanate trimers in consideration of non-yellowing and weather resistance.

Hereinafter, preferable Examples of the present disclosure and Comparative Examples will be described. However, the following Examples are merely a preferred embodiment of the present disclosure, and the present disclosure is not limited to the following Examples.

### Preparation Example 1: Biomass Polyurethane Resin

A thermometer, a condenser, a stirrer, a nitrogen inlet, and a heater were attached to a four-neck flask. An organic solvent was prepared by mixing methyl isobutyl ketone and butyl acetate in a weight ratio of 1:2 in the flask, and 125 parts by weight of an acrylic resin and 0.06 parts by weight of dibutyl tin laurate were added based on 100 parts by weight of the organic solvent, and heated to 80° C. while stirring under nitrogen. Then, 50 parts by weight of isophorone diisocyanate based on 100 parts by weight of the acrylic resin was added dropwise at a uniform rate for 1 hour to prepare a mixed solution. Then, while maintained for 1 hour, 130 parts by weight of DVP R200 (biopolyol) of Petronas manufactured by an ozone decomposition method was added based on 100 parts by weight of the mixed solution, and the mixture was reacted for 1 hour. Thereafter, dibutyltin laurate was added separately three times at 1-hour intervals in an amount of 0.06 parts by weight based on 100 parts by weight of the organic solvent, and reacted for 2 hours to obtain a biomass polyurethane resin. The obtained biomass polyurethane resin containing hydroxyl groups was found to have a weight average molecular weight of 40,000 to 43,000 g/mol, a glass transition temperature of 30 to 32° C., and a hydroxyl value of 230 mgKOH/g.

### Preparation Example 2: First Biomass Acrylic Resin

490 g of n-butyl acetate as a solvent was placed in a four-neck flask equipped with a stirrer, replaced with nitrogen gas, heated to 120° C. while stirring, and maintained constantly. A mixture of 70 g of isobornyl acrylate as a biomass-based alicyclic group-containing acrylic monomer, 490 g of methyl methacrylate as an aliphatic group-containing methacrylic monomer, 133 g of 2-hydroxyethyl methacrylate as a hydroxyl group-containing methacrylic monomer, 7 g of methacrylic acid as a carboxyl group-containing methacrylic monomer, and 28 g of tert-butyl peroxy-2-ethylhexanoate as an initiator was added dropwise to the solvent at a uniform rate over 4 hours. After completion of the dropwise addition, the mixture was aged at a reaction temperature of 120° C. for 1 hour, and then, added with a solution of 2 g of tert-amyl peroxy-2-ethylhexanoate dissolved in 21 g of n-butyl acetate and reacted with an unreacted monomer while further stirring for 2 hours, and then diluted with 161 g of n-butyl acetate to prepare a biomass acrylic resin. The obtained biomass acrylic resin was found to have an acid value of 3.0 mgKOH/g, a weight average molecular weight of 35,000 to 40,000 g/mol, a glass transition temperature of 75 to 80° C., and a hydroxyl value of 30 mgKOH/g.

### Preparation Example 3: Second Biomass Acrylic Resin

420 g of n-butyl acetate as a solvent was placed in a four-neck flask equipped with a stirrer, replaced with nitrogen gas, heated to 120° C. while stirring, and maintained constantly. A mixture of 490 g of methyl methacrylate as a biomass-based, aliphatic group-containing methacrylic monomer, 133 g of ethyl methacrylate, 70 g of 2-hydroxyethyl methacrylate as a hydroxyl group-containing methacrylic monomer, 7 g of acrylic acid as a carboxyl group-containing methacrylic monomer, and 14 g of tert-butyl peroxy-2-ethylhexanoate as an initiator was added dropwise in the solvent at a uniform rate over 3 hours. After completion of the dropwise addition, the mixture was aged at a reaction temperature of 120° C. for 1 hour, and then, added with a solution of 2 g of tert-amyl peroxy-2-ethylhexanoate dissolved in 21 g of n-butyl acetate and reacted with an unreacted monomer while further stirring for 2 hours, and then diluted with 231 g of n-butyl acetate to prepare a biomass acrylic resin. The obtained biomass acrylic resin was found to have an acid value of 2.5 mgKOH/g, a weight average molecular weight of 20,000 to 30,000 g/mol, a glass transition temperature of 80 to 90° C., and a hydroxyl value of 25 mgKOH/g.

### Example 1

20 wt % of the biomass polyurethane resin, 30 wt % of the first biomass acrylic resin, and 15 wt % of the second biomass acrylic resin prepared in Preparation Examples 1 to 3 were mixed with 37.5 wt % of additives (2.5 wt % of a pigment, 0.5 wt % of a reaction catalyst, 2 wt % of a matting agent, 4.7 wt % of an anti-settling agent, 0.3 wt % of a surface additive, 5 wt % of a wetting and dispersing agent, and 20 wt % of a solvent) to manufacture a bio coating composition. Thereafter, an article to be coated was coated using 25 parts by weight of a curing agent comprising hexamethylene diocyanate trimer based on 100 parts by weight of the bio coating composition, and then cured at 80° C. for 30 minutes to manufacture a coating film comprising the bio coating composition.

### Example 2

A coating film comprising a bio coating composition was manufactured in the same manner as in Example 1, except that recycled carbon black (Continua 8510P, BIRLA) as a recycled pigment was comprised instead of the pigment.

### Comparative Examples 1 to 13

Coating films were manufactured using coating compositions having the contents and conditions shown in Table 1 below.

TABLE 1

| | | | | | | Additive (wt %) | | | | | | | |
|---|---|---|---|---|---|---|---|---|---|---|---|---|---|
| | Resin (wt %) | | | | | | | | | | | Wetting | |
| | | | Biomass | | | | | | | Anti- | | and | |
| | Acrylic | Acrylic | Acrylic | Acrylic | Polyurethane | | Recycled | Reaction | Matting | settling | Surface | dispersing | |
| | Resin-1 | Resin-2 | Resin-1 | Resin-2 | resin | Pigment | pigment | catalyst | agent | agent | additive | agent | Solvent |
| Com. | 40 | 15 | 0 | 0 | 10 | 2.5 | 0 | 0.5 | 2.0 | 4.7 | 0.3 | 5.0 | 20 |
| Ex. 1 | | | | | | | | | | | | | |
| Com. | 35 | 10 | 0 | 0 | 20 | 2.5 | 0 | 0.5 | 2.0 | 4.7 | 0.3 | 5.0 | 20 |
| Ex. 2 | | | | | | | | | | | | | |
| Com. | 30 | 5 | 0 | 0 | 30 | 2.5 | 0 | 0.5 | 2.0 | 4.7 | 0.3 | 5.0 | 20 |
| Ex. 3 | | | | | | | | | | | | | |
| Com. | 0 | 0 | 45 | 0 | 20 | 2.5 | 0 | 0.5 | 2.0 | 4.7 | 0.3 | 5.0 | 20 |
| Ex. 4 | | | | | | | | | | | | | |
| Com. | 0 | 0 | 40 | 5 | 20 | 2.5 | 0 | 0.5 | 2.0 | 4.7 | 0.3 | 5.0 | 20 |
| Ex. 5 | | | | | | | | | | | | | |
| Com. | 0 | 0 | 35 | 10 | 20 | 2.5 | 0 | 0.5 | 2.0 | 4.7 | 0.3 | 5.0 | 20 |
| Ex. 6 | | | | | | | | | | | | | |
| Com. | 0 | 0 | 20 | 25 | 20 | 2.5 | 0 | 0.5 | 2.0 | 4.7 | 0.3 | 5.0 | 20 |
| Ex. 7 | | | | | | | | | | | | | |
| Com. | 35 | 10 | 0 | 0 | 20 | 0 | 2.5 | 0.5 | 2.0 | 4.7 | 0.3 | 5.0 | 20 |
| Ex. 8 | | | | | | | | | | | | | |
| Com. | 30 | 5 | 0 | 0 | 30 | 0 | 2.5 | 0.5 | 2.0 | 4.7 | 0.3 | 5.0 | 20 |
| Ex. 9 | | | | | | | | | | | | | |
| Com. | 0 | 0 | 45 | 0 | 20 | 0 | 2.5 | 0.5 | 2.0 | 4.7 | 0.3 | 5.0 | 20 |
| Ex. 10 | | | | | | | | | | | | | |
| Com. | 0 | 0 | 40 | 5 | 20 | 0 | 2.5 | 0.5 | 2.0 | 4.7 | 0.3 | 5.0 | 20 |
| Ex. 11 | | | | | | | | | | | | | |
| Com. | 0 | 0 | 35 | 10 | 20 | 0 | 2.5 | 0.5 | 2.0 | 4.7 | 0.3 | 5.0 | 20 |
| Ex. 12 | | | | | | | | | | | | | |
| Com. | 0 | 0 | 20 | 25 | 20 | 0 | 2.5 | 0.5 | 2.0 | 4.7 | 0.3 | 5.0 | 20 |
| Ex. 13 | | | | | | | | | | | | | |
| Ex. 1 | 0 | 0 | 30 | 15 | 20 | 2.5 | 0 | 0.5 | 2.0 | 4.7 | 0.3 | 5.0 | 20 |
| Ex. 2 | 0 | 0 | 30 | 15 | 20 | 0 | 2.5 | 0.5 | 2.0 | 4.7 | 0.3 | 5.0 | 20 |

Pigment: MONACH 1300 (manufacturer: CABOT)
Recycled pigment: Continua 8510P (manufacturer: BIRLA)
Reaction catalyst: dibutyltin dilaurate
Matting agent: TS-100 (manufacturer: DEGOSSA)
Anti-settling agent: HPA-407A
Surface additive: BYK-306
Wetting and dispersing agent: DISPERBYK-2050 (manufacturer: BYK)
Solvent: Mixture of ketone and acetate

### Experimental Example (Property Evaluation)

The properties of the coating films of Examples and Comparative Examples were evaluated using the following measurement method, and the results were shown in Tables 2 and 3 below. In addition, the carbon emissions of Examples and Comparative Examples were calculated using the following calculation method, and the results were shown in Table 4 below.

### Measurement Method

Measurement of biomass content: ASTM D6866 (measures the biomass content by detecting C14, which does not exist in petroleum-derived products.)

Sunscreen resistance: 0.25 g of sunscreen was applied to a white cotton cloth, and then the applied area adhered to the surface of a coating film, and the appearance and left under conditions of 80° C.×60 min and then the appearance and the adhesion were confirmed. Aromatic resistance: An aluminum cap with a diameter of 20 mm was attached to the surface of the coating film using an adhesive, 0.2 ml of an aromatic evaluation solution was dropped inside the aluminum cap using a dropper, and left in a constant temperature bath at 70±2° C. for 30 minutes, and then washed with a neutral detergent and dried, and then the appearance and adhesion were confirmed.

Heat cycle resistance: The appearance and adhesion were confirmed after removing moisture from a coating specimen left under a predetermined cycle condition of heat and humidity according to a specified standard.

Moisture resistance: The appearance and adhesion were confirmed after removing moisture from the coating specimen left at a temperature of 50° C. for 240 hours.

Hydrolysis resistance: After leaf for 168 hours under the conditions of temperature 90° C. and humidity 95%, the adhesion, scratch resistance, and degree of discoloration were confirmed.

Light resistance: According to the regulations of SAE J 2412, the appearance and adhesion were confirmed after irradiation under the conditions of 1050 KJ/m² (340 nm) or 126 MJ/m² (300 to 400 nm) of xenon arc. The appearance evaluation of light resistance was performed using a spectrophotometer to measure the color difference values (L*a*b*) before and after the evaluation, and then a difference ΔE* was calculated.

### Calculation Method

The carbon emissions were calculated based on the criteria calculated from the Korea Environmental Industry & Technology Institute National LCI database as follows.
1.86 kg CO₂ was generated when producing 1 kg of synthetic resin
0.56 kg CO₂ was generated when producing 1 kg of bio resin
2.39 kg CO₂ was generated when producing 1 kg of general carbon black
0.74 kg CO₂ was generated when producing 1 kg of recycled carbon black

TABLE 2

| | Biomass | | | | | | | |
|---|---|---|---|---|---|---|---|---|
| | content | | | | | | | |
| | (theoretical | Sunscreen | Aromatic | Heat cycle | Moisture | Hydrolysis | Light | Coating |
| | value) | resistance | resistance | resistance | resistance | resistance | resistance | appearance |
| Com. | 10 | OK | OK | OK | OK | OK | OK | good |
| Ex. 1 | | (M 1.5) | (M 1.5) | (M 1.5) | (M 1.5) | (M 1.5) | (M 1.5) | |
| | | | | | ΔE* < 1.5 | | ΔE* < 1.5 | |
| Com. | 15 | N.G | N.G | OK | OK | N.G | N.G | good |
| Ex. 2 | | (M 3.0) | (M 3.5) | (M 2.5) | (M 2.5) | (M 4.0) | (M 3.0) | |
| | | | | | ΔE* < 1.5 | | ΔE* < 1.5 | |
| Com. | 21 | N.G | N.G | N.G | N.G | N.G | N.G | good |
| Ex. 3 | | (M 5.0) | (M 5.0) | (M 3.5) | (M 4.0) | (M 5.0) | (M 3.0) | |
| | | | | | ΔE* < 1.5 | | ΔE* < 1.5 | |
| Com. | 20 | OK | OK | OK | N.G | N.G | N.G | poor |
| Ex. 4 | | (M 1.5) | (M 1.5) | (M 1.5) | (M 3.0) | (M 3.0) | (M 4.0) | |
| | | | | | ΔE* < 1.5 | | ΔE* < 1.5 | |
| Com. | 20 | OK | OK | OK | OK | N.G | N.G | poor |
| Ex. 5 | | (M 1.5) | (M 1.5) | (M 1.0) | (M 1.0) | (M 3.0) | (M 4.0) | |
| | | | | | ΔE* < 1.5 | | ΔE* < 1.5 | |
| Com. | 21 | OK | OK | OK | OK | OK | OK | poor |
| Ex. 6 | | (M 1.5) | (M 1.5) | (M 1.0) | (M 1.0) | (M 1.5) | (M 2.0) | |
| | | | | | ΔE* < 1.5 | | ΔE* < 1.5 | |
| Com. | 21 | N.G | N.G | OK | OK | OK | OK | poor |
| Ex. 7 | | (M 3.0) | (M 4.0) | (M 1.0) | (M 1.5) | (M 1.5) | (M 2.0) | |
| | | | | | ΔE* < 1.5 | | ΔE* < 1.5 | |
| Ex. 1 | 21 | OK | OK | OK | OK | OK | OK | good |
| | | (M 1.5) | (M 1.5) | (M 1.0) | (M 1.0) | (M 1.0) | (M 1.5) | |
| | | | | | AE* < 1.5 | | AE* < 1.5 | |

The M grade represents grading adhesion results, and values below M 2.5 correspond to a target value. (As M 1 → M 5, the area that falls off after the adhesion test increases.)

As shown in Table 2 above, it was confirmed that Example 1 satisfied 20% or more of the bio content which was the domestic biomass content standard and also satisfied various properties required for automotive interior materials.

TABLE 3

| | Biomass | | | | | | |
|---|---|---|---|---|---|---|---|
| | content | | | | | | |
| | (theoretical | Sunscreen | Aromatic | Heat cycle | Hydrolysis | Moisture | Coating |
| | value) | resistance | resistance | resistance | resistance | resistance | appearance |
| Com. | 15 | N.G | N.G | OK | OK | N.G | good |
| Ex. 8 | | (M 3.0) | (M 3.5) | (M 2.5) | (M 2.5) | (M 4.0) | |
| | | | | | ΔE* < 1.5 | | |
| Com. | 21 | N.G | N.G | N.G | N.G | N.G | good |
| Ex. 9 | | (M 5.0) | (M 5.0) | (M 3.5) | (M 4.0) | (M 5.0) | |
| | | | | | ΔE* < 1.5 | | |
| Com. | 20 | OK | OK | OK | N.G | N.G | poor |
| Ex. 10 | | (M 1.5) | (M 1.5) | (M 1.5) | (M 3.5) | (M 3.5) | |
| | | | | | ΔE* < 1.5 | | |
| Com. | 20 | OK | OK | OK | OK | N.G | poor |
| Ex. 11 | | (M 1.5) | (M 1.5) | (M 1.0) | (M 1.0) | (M 3.0) | |
| | | | | | ΔE* < 1.5 | | |
| Com. | 21 | OK | OK | OK | OK | OK | poor |
| Ex. 12 | | (M 1.5) | (M 1.5) | (M 1.0) | (M 1.0) | (M 1.5) | |
| | | | | | ΔE* < 1.5 | | |
| Com. | 21 | N.G | N.G | OK | OK | OK | poor |
| Ex. 13 | | (M 3.0) | (M 4.0) | (M 1.0) | (M 1.5) | (M 1.5) | |
| | | | | | ΔE* < 1.5 | | |
| Ex. 2 | 21 | OK | OK | OK | OK | OK | good |
| | | (M 1.5) | (M 1.5) | (M 1.0) | (M 1.0) | (M 1.0) | |
| | | | | | ΔE* < 1.5 | | |

The M grade represents grading adhesion results, and values below M 2.5 correspond to a target value. (As M 1 → M 5, the area that falls off after the adhesion test increases.)

As shown in Table 3 above, it was confirmed that Example 2 satisfied 20% or more of the bio content which was the domestic biomass content standard and also satisfied all various properties required for automotive interior materials even while further securing eco-friendliness by using recycled pigments.

TABLE 4

| | Carbon emissions (unit) |
|---|---|
| Example 1 | 662.9 |
| Example 2 | 572.1 |
| Comparative Example 1 | 711.1 |
| General coating | 759.4 |

As may be seen in Table 4 above, it may be confirmed that Example 1 comprising the biomass resin may reduce carbon emissions compared to Comparative Example 1 and general coatings without comprising the biomass resin, and additionally, Example 2 using recycled pigments may further reduce carbon emissions.

Therefore, it may be seen that the bio coating composition of the present disclosure is not only eco-friendly, but also may secure excellent durability properties of the coating film.

As described above, the embodiments have been mainly described, but are only examples and do not limit the present disclosure, and those skilled in the art to which the present disclosure pertains will appreciate that various modifications and applications not illustrated above may be made without departing from the essential characteristics of the embodiments of the present disclosure. For example, each component specifically shown in embodiments may be modified and implemented. In addition, differences related to these modifications and applications should be construed as being comprised in the scope of the present disclosure defined in the appended claims.

1. A coating composition comprising:
a) a polyurethane resin; and
b) an acrylic resin component,
wherein the acrylic resin component comprises:
i) a first acrylic resin having an acid value of about 3.5 mgKOH/g or less and a glass transition temperature of about 75 to 80° C.; and ii) a second acrylic resin having an acid value of about 3.0 mgKOH/g or less and a glass transition temperature of about 80 to 90° C.

2. The coating composition of claim 1 wherein at least 70 weight percent of the polyurethane resin and acrylic resin component are derived from biomass-related materials.

3. The coating composition of claim 1, wherein the acrylic resin component comprises an aliphatic group-containing methacrylic monomer, an aliphatic group-containing acrylic monomer, an alicyclic group-containing methacrylic monomer, an alicyclic group-containing acrylic monomer, an aromatic group-containing methacrylic monomer, an aromatic group-containing acrylic monomer, a hydroxyl group-containing methacrylic monomer, and a hydroxyl group-containing acrylic monomer.

4. The coating composition of claim 3, wherein the aliphatic group-containing methacrylic monomer comprises one selected from the group consisting of butyl methacrylate, methyl methacrylate, ethyl methacrylate, 2-ethylhexyl methacrylate, lauryl methacrylate, hydroxyethyl methacrylate, and combinations thereof,
the aliphatic group-containing acrylic monomer comprises one selected from the group consisting of butylacrylate, ethyl acrylate, and combinations thereof,
the alicyclic group-containing methacrylic monomer comprises one selected from the group consisting of isobornyl methacrylate, cyclohexyl methacrylate, and combinations thereof,
the alicyclic group-containing acrylic monomer comprises one selected from the group consisting of 2-ethylhexylacrylate, isobornyl acrylate, trimethylcyclohexylacrylate, and combinations thereof, and
the hydroxyl group-containing methacrylic monomer comprises one selected from the group consisting of methacrylic acid, acrylic acid, 2-hydroxyethyl methacrylate and combinations thereof.

5. The coating composition of claim 1, wherein the acrylic resin component has a hydroxyl value of about 50 to 100 mgKOH/g.

6. The coating composition of claim 1 further comprising an additive compnent.

7. The coating composition of claim 6 wherein the additive component comprises one selected from the group consisting of pigments, wetting and dispersing agents, reaction catalysts, matting agents, anti-settling agents, surface additives, solvents, and combinations thereof.

8. The coating composition of claim 7, wherein the pigment is a recycled pigment.

9. The coating composition of claim 1, wherein the olyurethane resin has a weight average molecular weight of about 40,000 to 43,000 g/mol, a hydroxyl value of about 200 to 300 mgKOH/g, and a glass transition temperature (Tg) of about 30 to 32° C.

10. The coating composition of claim 1, wherein the coating composition comprises about 15 to 25 wt % of the polyurethane resin;
about 25 to 30 wt % of the first acrylic resin;
about 10 to 20 wt % of the second acrylic resin; and
about 19 to 47 wt % of an additive.

11. The coating composition of claim 8, wherein the coating composition comprises about 15 to 25 wt % of a polyurethane resin;
about 25 to 30 wt % of the first acrylic resin;
about 10 to 20 wt % of the second acrylic resin;
about 1.0 to 3.5 wt % of the recycled pigment;
about 0.1 to 1.5 wt % of the reaction catalyst;
about 1.5 to 3.5 wt % of the matting agent;
about 3.0 to 7.0 wt % of the anti-settling agent;
about 0.1 to 1.0 wt % of the surface additive;
about 1 to 10 wt % of the wetting and dispersing agent; and
about 10 to 25 wt % of the solvent.

12. A method for manufacturing a bio coating composition comprising:
preparing a biomass acrylic resin;
preparing a biomass polyurethane resin; and
preparing a coating composition by mixing the biomass acrylic resin, and the biomass polyurethane resin,
wherein the biomass acrylic resin comprises a first biomass acrylic resin having an acid value of about 3.5 mgKOH/g or less and a glass transition temperature of about 75 to 80° C.; and
a second biomass acrylic resin having an acid value of about 3.0 mgKOH/g or less and a glass transition temperature of about 80 to 90° C.

13. The method of claim 12, wherein the biomass acrylic resin is prepared by radical-polymerizing about 98 to 99.9 wt % of the monomer and about 0.1 to 2 wt % of the radical initiator.

14. The method of claim 12, wherein the biomass acrylic resin comprises at least one monomer selected from the group consisting of an aliphatic group-containing methacrylic monomer, an aliphatic group-containing acrylic monomer, an alicyclic group-containing methacrylic monomer, an alicyclic group-containing acrylic monomer, an aromatic group-containing methacrylic monomer, an aromatic group-containing acrylic monomer, and a hydroxyl group-containing acrylic monomer.

15. The method of claim 12, wherein the biomass acrylic resin has a hydroxyl value of about 50 to 100 mgKOH/g.

16. The method of claim 12, wherein the biomass polyurethane resin has a weight average molecular weight of about 40,000 to 43,000 g/mol, a hydorxyl value of about 200 to 300 mgKOH/g, and a glass transition temperature (Tg) of about 30 to 32° C.

17. The method of claim 12, wherein the solvent used in preparing the biomass acrylic resin is an ester or a ketone.

18. The method of claim 12, further comprising adding a curing agent in an amount of about 5 to 30 parts by weight based on 100 parts by weight of the coating composition.

19. The method of claim 12, wherein the coating composition is prepared by mixing the biomass acrylic resin, and the biomass polyurethane resin, and an additive, and wherein the additive comprises about 1.0 to 3.5 wt % of a recylced pigment.

20. A bio coating composition comprising:
about 15 to 25 wt % of a biomass polyurethane resin;
about 25 to 30 wt % of the first biomass acrylic resin; and
about 10 to 20 wt % of the second biomass acrylic resin,
wherein the first biomass acrylic resin has an acid value of about 3.5 mgKOH/g or less and a glass transition temperature of about 75 to 80° C.; and the second biomass acrylic resin has an acid value of about 3.0 mgKOH/g or less and a glass transition temperature of about 80 to 90° C.
